(19) United States
(12) Patent Application Publication
(10) Pub. No.: US 2009/0117235 A1
(43) Pub. Date: May 7, 2009

(54) Healthier meat products and process therefor

(76) Inventor: Vincent Staudenmyer, Williamsburg, MO (US)

Correspondence Address: Vincent Staudenmyer, 8885 County Road 134, Williamsburg, MO, 63388, US

(21) Appl. No.: 11/982,571

(22) Filed: Nov. 2, 2007

(51) Int. Cl. A23L 1/317; A23L 1/31; A23L 1/314

(52) U.S. Cl. 426/105; 426/646; 426/641; 426/282; 426/284

(57) ABSTRACT

A healthier meat product, and process for making same, comprising a mixture of meat and at least one edible oil high in polyunsaturated fat and/or monounsaturated fat, the oil preferably being naturally occurring and unhydrogenated.

### FIELD OF INVENTION

The present invention relates to healthier meat products comprising one or more edible oils high in polyunsaturated fat and/or monounsaturated fat. More particularly, the present invention comprises lean meat mixed with olive oil. Furthermore, there is provided a process for preparing a healthier meat product.

### BACKGROUND OF THE INVENTION

There is a growing concern on the part of the modern consumer about the nutritional value of a variety of today's food products. As a result, there is an increasing demand for healthier foods, e.g., foods that are lower in saturated fats, lower in low-density lipoprotein cholesterol, higher in high-density lipoprotein cholesterol, etc. To this end, a healthier meat product is greatly desirable.

While it is the mainstay of the diets of many, meat tends to be high in saturated fats which, according to scientific evidence, are high in low-density lipoprotein cholesterol. This can represent a significant health hazard, leading to the development of cardiovascular disease. Another health concern associated with many meat products is the high amount of salt which is added in order to improve the binding characteristics due to the fact that salt aids in extracting the native water binding component myosin from the meat. Furthermore, many meat products contain chemical additives such as water binding agents including phosphates, emulsifying additives and anti-oxidants, which is less than desirable from a health standpoint.

On the other hand, the presence of unhealthy fats in traditional high-fat meat products often provides a desirable influence on the texture and palatability thereof. Traditional meat products having a substantially reduced fat content tend to become dry, tough and less succulent.

The prior art is replete with attempts to overcome this dilemma and provide a palatable, healthier meat having a desirable texture. U.S. Pat. Nos. 5,238,701, 6,419,977 B1, and 7,026,007 B2 teach ways to create a vegetable fat emulsion which includes the addition of milk proteins thereto. U.S. Pat. Nos. 5,468,510, 5,654,028, 6,419,977 and 7,026,007 B2 teach ways to create a vegetable fat emulsion which includes the addition of starch thereto. U.S. Pat. Nos. 5,468,510 and 5,654,028 further teach adding dietary fiber to their respective vegetable fat emulsions. In each of these prior art inventions, the vegetable fat emulsions serve to replace the animal fat missing from lean ground meat when mixed therewith.

U.S. Pat. No. 2007/0104835 A1 teaches a method for preparing fermented meat products, and includes mixing salt, sugar, preservatives and cultures into the meat before vegetable oil is added to the mixture.

None of the aforementioned prior art refers to a healthy meat product produced wherein the monounsaturated or polyunsaturated oil, such as olive oil, is mixed directly with the meat without a carrier for the oil, i.e., without the creation of an emulsifier including, in addition to the oil, milk proteins, starches, dietary fiber, sugars, salts, or preservatives. A meat product wherein a healthy oil is mixed directly with the meat would eliminate the time and expense of adding the emulsifying ingredients, while yielding a healthier meat product, especially for those who have allergies to any of the aforementioned emulsifying ingredients.

### SUMMARY OF THE INVENTION

The present invention is directed to the surprising and unexpected discovery that monounsaturated and/or polyunsaturated oils, such as fish, nuts, seeds and vegetable oils can be added directly to comminuted meats, i.e., without first mixing the oils in an emulsifier or a carrier, to produce healthier and tastier meat products more simply and economically than were heretofore available.

It is therefore an object of the present invention to provide a meat product and process therefor wherein one or more monounsaturated and/or polyunsaturated oils are mixed directly with comminuted meat and left to set for a sufficient period of time to allow for thorough absorption of the oils into the comminuted meat.

It is another object of the present invention to provide a meat product and process therefor wherein the monounsaturated and/or polyunsaturated oils are mixed directly with comminuted meat before any binder, cure and spices are added to the meat mixture, thereby preventing the binder, cure and spices from inhibiting absorption of the oils by the meat.

It is yet another object of the present invention to provide a meat product and process therefor wherein the mixture of comminuted meat, oil, binder, cure and spices is stuffed into at least one casing.

It is still another object of the present invention to provide a meat product and process therefor wherein the casing of raw mixture is refrigerated at a regulated temperature and for a regulated time to allow certain processes to form a coherent matrix that provides for finished product oil retention to prepare the casing for freezer storage or for cooking.

It is a further object of the present invention to provide a meat product and process therefor wherein the casing of raw mixture is cooked at a predetermined optimum temperature, designed to minimize the expulsion of oil, until the core temperature of the casing reaches a predetermined optimum temperature.

It is a still further object of the present invention to provide a meat product and process therefor wherein the casing of cooked mixture is rapidly cooled.

It is yet another object of the present invention to provide a meat product and process therefor wherein the casing of cooked mixture is rotated so that it is turned over at predetermined intervals during the rapid cooling process.

It is a further object of the present invention to provide a meat product and process therefor wherein the casing of cooked and cooled mixture can be stored long-term in a freezer, stored short term in a refrigerator, or eaten immediately.

It is a still further object of the present invention to provide a meat product and process therefor wherein the casing of cooked and cooled mixture can be reheated before being consumed.

It is another object of the present invention to provide a meat product and process therefor wherein the mixture is of a particulate size which makes it possible to form coherent hamburger patties.

It is yet another object of the present invention to provide a meat product and process therefor wherein the mixture is a coherent forcemeat mixture.

It is a further object of the present invention to provide a meat product and process therefor that leaves a clean taste in one's mouth rather than a coating of heavy fat that is so pronounced in high saturated fat products.

The foregoing and other objectives, features and advantages of the invention will be more readily understood upon consideration of the following detailed description of certain preferred embodiments of the invention.

### DETAILED DESCRIPTION OF THE INVENTION

The present invention will be well understood and its advantages and other characteristics will become apparent during the following description of preferred embodiments, and processes therefor, applied to making healthier meat products.

In the present invention, meat of any variety of species or grade, or combination of same, can be used. This includes Choice or Prime grade meats although, due to the high animal fat content of these grades of meat, some health benefit is lost. In a preferred embodiment of the present invention, Good grade meat is used, regardless of the species, due to its lean, reduced-fat content.

After selecting the batch of meat or meats, the batch is rough-ground. A Hobart model 4632 grinder employing a grinding plate with the largest holes, (a ⅜″ plate), works well for this purpose.

Thereafter, any monounsaturated or polyunsaturated edible oil, such as fish, nut seed or vegetable oil is added to the rough-ground batch of meat. When using vegetable oil, the American Heart Association recommends using a naturally occurring, unhydrogenated oil such as canola, safflower, sunflower or olive oil. In a preferred embodiment of the present invention, Bertolli Extra Light Tasting Olive Oil is used. It is important to note that the oil is added directly to the batch of meat in an unadulterated form, without the addition of protein substances or mixes to carry the oil, nor the addition of cultures to cause fermentation of the meat product.

The oil is then thoroughly mixed into the meat batch. A Hobart model H-600 mixer with a standard paddle blade mixing for 60 seconds on low speed works well for this purpose.

The mixture is then allowed to set for at least ten minutes. This is an important step, as it enables the meat to properly absorb the oil.

The mixture of meat and oil is then finely-ground. A Hobart model 4632 grinder employing a hamburger grinding plate or a grinding plate with the smallest holes works well for this purpose.

A curing agent, binder, sodium erythorbate and any combination of optional spices are combined in water. In a preferred embodiment of the present invention, one ounce of water is used for every pound of meat. Using a manual potato masher device, the binder is ground until fully dissolved in the water.

The water solution of curing agent, binder, sodium erythorbate and optional spices is then thoroughly mixed into the meat and oil mixture to form an end-product mixture. A Hobart model H-600 mixer using a standard paddle blade for two minutes on low speed is recommended for this purpose.

It should be noted that a curing agent is a must for the proper formulation of the meat products of the present invention. Any standard industry meat cure will work. In a preferred embodiment of the present invention, a cure containing salt, 6.25% sodium nitrite and 0.00099% FD&C red #3 is used.

The sodium erythorbate is added to speed the impact of the cure, as well as speed the natural enzymatic activity of the meat, thereby causing the meat to solidify and retain or hold in moisture and oil. The binder acts in conjunction with the curing agent and sodium erythorbate to solidify the meat mixture mass and prevent moisture and oil migrating during cooking. In a preferred embodiment of the present invention, 414 Hunter's Special Meat Binder is used.

The end-product mixture is then stuffed into casings. A Dick stuffer model D-73779 works well for this purpose. Any type of casing that seals completely can be used. In a preferred embodiment of the present invention, a fibrous casing is used. The casings are then sealed by tying both ends tightly.

The casing can be of any desired diameter. In one embodiment of the present invention, the particulate size of the end-product mixture makes it possible to form coherent hamburger patties, (typically in the range of 2-10 mm). In this embodiment, a casing diameter of approximately four inches is preferred. In another embodiment of the present invention, the end-product mixture is a forcemeat mixture, i.e., a mixture which forms a stable homogeneously integrated mass subjected to mechanical forces whereby the particle size of the ingredients is reduced to levels where the ingredients are no longer visually recognizable and where they form a defined integrated mass having a coherent homogeneous consistency essentially without visually recognizable particles. In this embodiment, a casing diameter of 1.5″ to 2.5″ is preferred.

The sealed casings are then cooled. In a preferred embodiment of the present invention, the sealed casings are subjected to a cooling temperature of 34 degrees F. for a dwell time of approximately 48 hours in a standard industry meat cooler to allow the end-product mixture to congeal and naturally achieve the desired consistency and entrapment of the oil.

At this point, the casings can be frozen for long-term storage, or can be cooked. In a preferred embodiment of the present invention, when the casings are cooked, they are subjected to a temperature of approximately 275 degrees F. until the core temperature of the casings reaches approximately 165 degrees F. The relatively low cooking temperature of 275 degrees F. helps prevent compressive forces (which area typical result of higher cooking temperatures) from forcing the moisture and oil out of the meat. A Blodgett commercial gas oven is recommended for this purpose.

The fully cooked end-product can be consumed warm, or it can be cooled. When cooling, the casings should be cooled as rapidly as possible without freezing them. In a preferred embodiment of the present invention, the casings are subjected to a temperature of zero degrees F., until the core temperature is 33 degrees F. A True Manufacturing refrigerator model GDM-49F is recommended for this purpose.

Turning the casings over during the rapid cooling process facilitates re-absorption of surface moisture and oil that might have escaped the meat, but is trapped inside the casing. In a preferred embodiment of the present invention, the casings are turned over at fifteen minutes and at twenty-five minutes into the rapid cooling process.

At this point, the casings can be frozen for long-term storage, refrigerated for short-term storage, consumed cold, or heated for consumption. When the particulate size of the end-product mixture makes it possible to form coherent hamburger patties, a casing can be laterally sliced in approximately ½″ segments (a Hobart meat slicer is recommended) and heated in a microwave oven just until warm, without losing the moisture and oil content.

In a preferred embodiment of the present invention, the ratio of ingredients comprising the end-product is as follows:

Every ten pounds of meat is mixed with 2¾ cups of oil, ½ ounce of curing agent, 1/10 ounce of sodium erythorbate and ¾ ounce of binder.

Thus, there has been shown and described multiple embodiments of healthier meat products, and processes for making same, that fulfill all of the objects and advantages sought therefor. Many changes, modifications, variations and other uses and applications of the present device will, however, become apparent to those skilled in the art after considering this specification. All such changes, modifications, variations and other uses and applications which do not depart from the spirit and scope of the invention are deemed to be covered by the invention which is limited only by the claims which follow.

1. A meat product comprising:
a mixture including comminuted meat and edible oil high in polyunsaturated fat and/or monounsaturated fat wherein the oil is introduced directly to the meat.

2. The meat product according to claim 1 wherein the mixture is allowed to set for at least 10 minutes.

3. The meat product according to claim 2 wherein the edible oil is olive oil.

4. The meat product according to claim 1 wherein the meat is lean meat.

5. The meat product according to claim 1 wherein the mixture includes a meat cure.

6. The meat product according to claim 5 wherein the meat cure contains salt, sodium nitrite and FD&C red #3.

7. The meat product according to claim 1 wherein the mixture includes sodium erythorbate.

8. The meat product according to claim 1 wherein the mixture includes a meat binder.

9. The meat product according to claim 1 wherein the mixture is sealed in at least one casing.

10. The meat product according to claim 9 wherein the casing is a fibrous casing.

11. The meat product according to claim 9 wherein the casing is refrigerated for at least 48 hours.

12. The meat product according to claim 1 1 wherein the refrigeration temperature is approximately 34 degrees F.

13. The meat product according to claim 9 wherein the meat is of a particle size that makes it possible to form coherent hamburger patties.

14. The meat product according to claim 13 wherein the casing is approximately four inches in diameter.

15. The meat product according to claim 14 wherein the casing can be sliced into lateral segments approximately one half of an inch thick.

16. The meat product according to claim 9 wherein the mixture is a coherent forcemeat mixture.

17. The meat product according to claim 16 wherein the casing is between 1.5 inches to 2.5 inches in diameter.

18. The meat product according to claim 9 wherein the casing is subjected to heat.

19. The meat product according to claim 18 wherein the heat to which the casing is subjected is approximately 275 degrees F.

20. The meat product according to claim 19 wherein the casing is subjected to the heat until the casing reaches a core temperature of approximately 165 degrees F.

21. The meat product according to claim 20 wherein the casing, upon reaching a core temperature of 165 degrees F., is subjected to a cooling temperature.

22. The meat product according to claim 21 wherein the cooling temperature is approximately zero degrees F.

23. The meat product according to claim 22 wherein the core temperature the casing is not allowed to fall below 33 degrees F.

24. The meat product according to claim 21 wherein the casing is turned over while being subjected to the cooling temperature.

25. The meat product according to claim 23 wherein the mixture is turned over at approximately fifteen minutes after being subjected to the cooling temperature and at approximately twenty-five minutes after being subjected to the cooling temperature.

26. A process for producing a meat product comprising the following steps:
(a) providing meat; and
(b) mixing edible oil high in polyunsaturated fat and/or monounsaturated fat directly into the meat.

27. The process according to claim 26 wherein the mixture of edible oil and meat is allowed to set for at least 10 minutes.

28. The process according to claim 27 wherein the edible oil is olive oil.

29. The process according to claim 26 wherein the meat is lean meat.

30. The process according to claim 28 wherein the meat is roughly-ground meat.

31. The process according to claim 30 further including the step of fine-grinding the olive oil and roughly-ground meat to yield a finely-ground mixture.

32. The process according to claim 31 further including the step of dissolving binder, cure, sodium erythorbate and optional seasons in water to form a solution.

33. The process according to claim 32 further including the step of mixing the solution into the finely-ground mixture to create an end-product mixture.

34. The process according to claim 33 further including the step of stuffing the end-product mixture into at least one casing.

35. The process according to claim 34 further including the step of sealing the casing.

36. The process according to claim 35 further including the step of refrigerating the sealed casing.

37. The process according to claim 36 wherein the sealed casing is refrigerated at approximately 34 degrees F. for at least 48 hours.

38. The process according to claim 37 further including the step of subjecting the sealed casing to heat.

39. The process according to claim 38 wherein the heat to which the sealed casing is subjected is approximately 275 degrees F.

40. The process according to claim 39 wherein the sealed casing is subjected to the heat until reaching a core temperature of 165 degrees F.

41. The process according to claim 40 further including the step of subjecting the sealed casing to a cooling temperature.

42. The process according to claim 41 wherein the cooling temperature to which the sealed casing is subjected is approximately zero degrees F.

43. The process according to claim 42 wherein the core temperature the casing is not allowed to fall below 33 degrees F.

44. The process according to claim 41 further including the step of turning the sealed casing over.

45. The process according to claim 43 wherein the sealed casing is turned over fifteen minutes after being subjected to the cooling temperature and at twenty-five minutes after being subjected to the cooling temperature.

46. The process according to claim 35 wherein the end-product mixture is of a particulate size which makes it possible to form coherent hamburger patties.

47. The process according to claim 46 wherein the diameter of the sealed casing is approximately four inches.

48. The process according to claim 47 further including the step of laterally slicing the sealed casing into ½-inch-thick slices.

49. The process according to claim 48 further including the step of heating a slice by microwave just until warm.

50. The process according to claim 35 wherein the end-product mixture is a coherent forcemeat mixture.

51. The process according to claim 50 wherein the diameter of the sealed casing is between 1.5 inches and 2.5 inches.

52. The meat product according to claim 1 wherein the edible oil is naturally occurring and unhydrogenated.

53. The process according to claim 25 wherein the edible oil is naturally occurring and unhydrogenated.
